(19) United States
(12) Patent Application Publication
(10) Pub. No.: US 2016/0091726 A1
(43) Pub. Date: Mar. 31, 2016

(54) POLARIZATION CONTROL UNIT AND 2D AND 3D IMAGE DISPLAY DEVICE HAVING THE SAME

(71) Applicant: LG DISPLAY CO., LTD., SEOUL (KR)

(72) Inventor: Ara YOON, SEOUL (KR)

(73) Assignee: LG DISPLAY CO., LTD., SEOUL (KR)

(21) Appl. No.: 14/574,109

(22) Filed: Dec. 17, 2014

(30) Foreign Application Priority Data
Sep. 30, 2014 (KR) 10-2014-0132073

(51) Int. Cl. G02B 27/26; G02F 1/1334

(52) U.S. Cl. CPC G02B 27/26; G02F 1/1334

(57) ABSTRACT

A polarization control unit which prevents moire and a 2D and 3D image display device having the same are provided. The polarization control unit in one example includes first and second substrates positioned opposite to each other, a first electrode disposed on a surface of the first substrate, a second electrode disposed on a surface of the second substrate, and a polymer-dispersed liquid crystal layer disposed between the first and second electrodes. The polymer-dispersed liquid crystal layer can include partition walls supporting the first and second substrates, and liquid crystal molecules arranged in a space defined by the partition walls. The partition walls can be arranged to form a inclination angle with the vertical plane.

This application claims the benefit of priority under 35 U.S.C. §119(a) to Korean Patent Application No. 10-2014-0132073 filed on Sep. 30, 2014, which is incorporated herein by reference for all purposes as if fully asset forth herein.

### BACKGROUND OF THE INVENTION

1. Field of the Invention

This document relates to a polarization control unit and a 2D (two dimensional) and 3D (three dimensional) image display device, and more particularly to, a polarization control unit which is capable of preventing moire, and a 2D and 3D image display device having the same.

2. Discussion of the Related Art

Stereoscopic image displays are categorized into stereoscopic displays and autostereoscopic displays. The stereoscopic displays, which use parallax image of the left and right eyes of a viewer with a high stereoscopic effect, include glasses-type displays and glasses-free displays, both of which have been put to practical use.

In the glasses displays, left- and right-eye parallax images are displayed on a direct-view display element or a projector by changing the direction of polarization or in a time-division manner, and polarization glasses or liquid crystal shutter glasses are used to represent a stereoscopic image. The glasses-free type displays are generally classified into parallax barrier displays and lenticular displays.

The parallax barrier displays present stereoscopic images separately to the left and right eyes of the viewer by selectively blocking light incident from the display panel using a barrier. A disadvantage of this technology is that it has significant luminance loss because the light passing through the barrier is reduced by about 50% or less as compared with incident light. The lenticular displays present stereoscopic images separately to the left and right eyes by using al lenticular lens positioned between the display panel and the viewer. The lenticular displays have less luminance loss than the parallax barrier displays.

However, the aforementioned parallax barrier and lenticular displays cannot display 2D images because optical separation cannot be switched on and off. Accordingly, a switchable display was proposed which has no luminance loss and is switchable between 2D and 3D displaying.

The switchable display is a display that switches between 2D and 3D displaying by controlling the voltage applied to the liquid crystals, and includes a polarization control unit for representing 3D image and polarizing lenses.

The related art polarization control unit includes an upper substrate and a lower substrate with electrodes formed on their opposing surfaces and a liquid crystal layer made of polymer-dispersed liquid crystal (PDLC) and disposed between the upper substrate and the lower substrate. The polymer in the polymer-dispersed liquid crystal layer forms a matrix structure that supports the liquid crystal molecules. The polymer alignment in the liquid crystal layer can be controlled by applying a voltage to the polarization control unit, thereby controlling light scattering and transmission.

According to the recent trend toward miniaturized and flexible electronic equipment, the related art polarization control unit is generally made in a plastic product, and therefore the electrodes formed on the upper and lower substrates are more likely to come into contact with each other due to external pressure or the weight of the substrates. Accordingly, there is the necessity of forming a proper partition wall to avoid contact between the electrodes of the polarization control unit. However, this partition wall can cause interference with the pixel electrodes of the display device that are positioned under it, resulting in a moire.

### SUMMARY OF THE INVENTION

An aspect of this document is to provide a polarization control unit which prevents moire caused by interference between partition walls of the polarization control unit and pixel electrodes of a display device, and a 2D and 3D image display device having the same.

An exemplary embodiment of the present invention provides a polarization control unit including first and second substrates positioned opposite to each other, a first electrode disposed on a surface of the first substrate opposing the second substrate, a second electrode disposed on a surface of the second substrate opposing the first substrate, and a polymer-dispersed liquid crystal layer disposed between the first and second electrodes. The polymer-dispersed liquid crystal layer includes a plurality of partition walls supporting the first and second substrates, and liquid crystal molecules arranged in a space defined by the partition walls. The partition walls are arranged to form a predetermined inclination angle with a vertical plane between the first and second substrates.

The partition walls may include: first partition walls arranged to form the predetermined inclination angle with a vertical plane between the first and second substrates; and second partition walls arranged to cross the first partition walls.

Alternatively, the partition walls can be arranged in parallel with each other in a same orientation.

The predetermined inclination angle may range from 10° to 33° or from 45° to 65°.

Another exemplary embodiment of the present invention provides a 2D/3D image display device including a display panel, a polarization control unit and a switchable lens unit. The display panel displays an image with light linearly polarized in a first direction. The polarization control unit selectively switches light of the first direction to light linearly polarized in a second direction orthogonal to the first direction. The switchable lens unit refracts light incident from the polarization control unit using a refractive index difference, and separates the refracted light into light for a left-eye image and light for a right-eye image to represent a 3D image or transmits the light incident from the polarization control unit without refraction to represent a 2D image.

The distance between the partition walls of the polarization control unit is an integer multiple of the size of a pixel electrode of the display panel.

The polarization control unit and 2D/3D image display device according to one or more embodiments of the present invention can prevent moire by eliminating interference with the pixel electrodes of the display device because the partition walls of the polarization control unit are arranged to form a predetermined inclination angle with a vertical plane.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view schematically illustrating a polarization control unit according to an exemplary embodiment of the present invention;

FIG. 2A is a top plan view illustrating one example of a partition wall of the polarization control unit of FIG. 1;

FIG. 2B is a top plan view illustrating another example of the partition wall of the polarization control unit of FIG. 1;

FIG. 3 is a cross-sectional view schematically illustrating a 2D/3D image display device having a polarization control unit according to an exemplary embodiment of the present invention;

FIG. 4A is a cross-sectional view for explaining the direction of polarization of light when no electric field is applied to the polarization control unit of FIG. 3;

FIG. 4B is a cross-sectional view for explaining the direction of polarization of light when an electric field is applied to the polarization control unit of FIG. 3;

FIG. 5 is a top plan view schematically illustrating one example of the relationship between the pixel electrodes of the display panel and the polarization control unit shown in FIG. 3;

FIG. 6 is a top plan view schematically illustrating another example of the relationship between the pixel electrodes of the display panel and the polarization control unit shown in FIG. 3;

FIG. 7 is a view illustrating a moire region and a moire-free region which appear depending on the inclination angle of the partition walls with respect to a vertical plane between the first and second substrates of the polarization control unit in the 2D/3D image display device according to the exemplary embodiment of the present invention; and

FIG. 8 is a photograph comparing the screen of the 2D/3 image display device according to the exemplary embodiment of the present invention and the screen of a related art 2D/3D image display device.

### DETAILED DESCRIPTION OF THE ILLUSTRATED EMBODIMENTS

Hereinafter, an exemplary embodiment of the present invention will be described in detail with reference to the accompanying drawings. Throughout the specification, the same reference numerals indicate the same components. In the following description, detailed descriptions of related well-known functions or configurations will be omitted if they would obscure the invention with unnecessary detail.

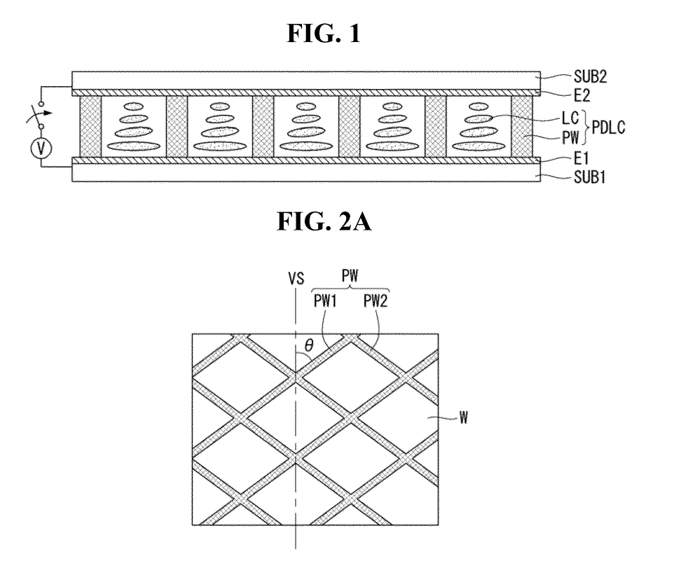

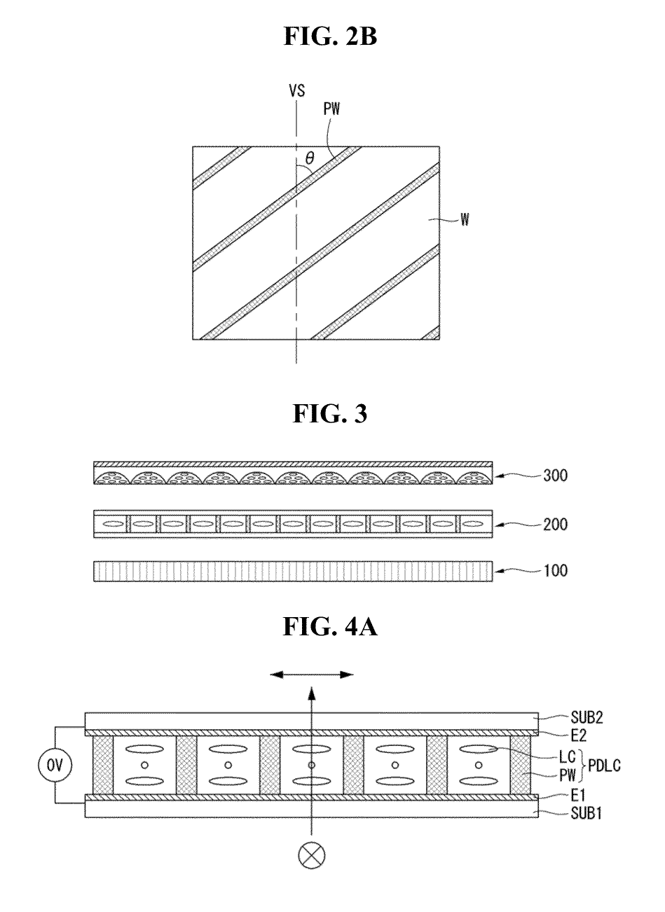

First of all, a polarization control unit according to an exemplary embodiment of the present invention will be described with reference to FIGS. 1 to 2B. FIG. 1 is a cross-sectional view schematically illustrating a polarization control unit according to an exemplary embodiment of the present invention. FIGS. 2A and 2B are top plan views illustrating a partition wall of the polarization control unit of FIG. 1.

Referring to FIGS. 1 to 2B, the polarization control unit according to the exemplary embodiment of the present invention includes a first substrate SUB1, a second substrate SUB2 positioned opposite the first substrate SUB1, a first electrode E1 and a second electrode E2 that are respectively disposed on the opposing surfaces of the first and second substrates SUB1 and SUB2, a polymer-dispersed liquid crystal layer PDLC disposed between the first and second electrodes E1 and E2, and a partition wall PW disposed on the polymer-dispersed liquid crystal layer PDLC.

The first substrate SUB1 and the second substrate SUB2 may be disposed of a transparent optically isotropic material. For example, they may be disposed of a film made of a plastic material such as polyethylene terephthalate (PET), triacetyl cellulose (TAC), or polycarbonate (PC). But the material of the first and second substrates SUB1 and SUB2 is not limited thereto. Alternatively, the first substrate SUB1 and the second substrate SUB2 may be formed of an organic or inorganic composite material as long as it is a transparent optically isotropic material.

The first electrode E1 and the second electrode E2 are formed of a transparent conductive material such as ITO (indium tin oxide), IZO (indium zinc oxide), or GZO (gallium-doped zinc oxide).

The polymer-dispersed liquid crystal layer PDLC includes a liquid crystal material LC and partition walls PW. The partition walls PW are formed by mixing the liquid crystal material and a monomeric polymer material in a liquid state and curing the mixture with ultraviolet rays using a photomask. By radiating ultraviolet rays using a photomask having a light blocking portion and a light transmitting portion, light incident through the light transmitting portion cures the polymer to form partition walls PW having a plurality of window W as shown in FIGS. 2A and 2B.

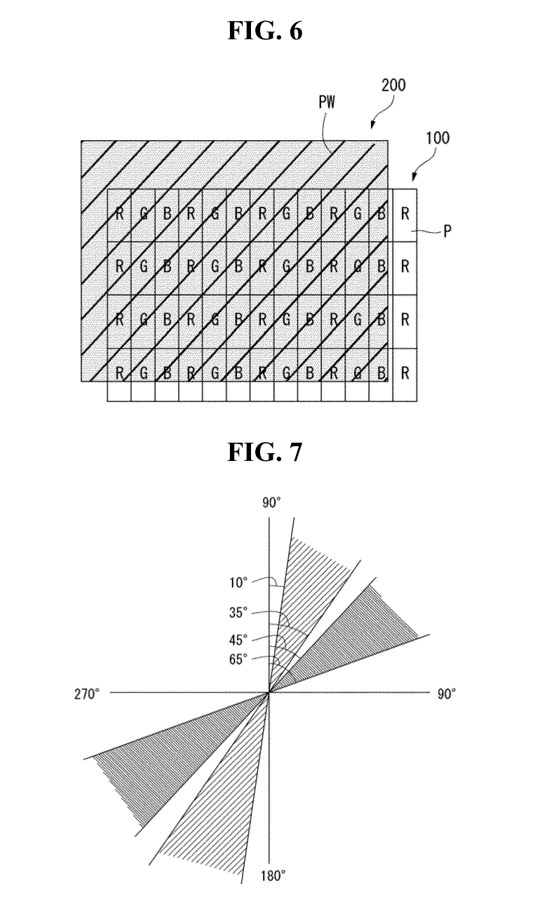

Referring to FIG. 2A, the partition walls PW of the polarization control unit comprise first partition walls PW1 configured to form a predetermined inclination angle θ with a vertical plane VS of the first substrate SUB1 and the second substrate SUB2, and second partition walls PW2 arranged to cross the first partition walls PW1 at approximately right angles. The distance (a first pitch) between the first partition walls and the distance (a second pitch) between the second partition walls are an integer multiple of the size of a pixel electrode of a display panel. This will be described later in detail with reference to FIGS. 5 and 6.

Referring to FIG. 2B, the partition walls PW of the polarization control unit are configured to form a predetermined inclination angle θ with a vertical plane VS between the first substrate SUB1 and the second substrate SUB2, and arranged side by side in the same orientation.

The inclination angle θ of each partition wall shown in the example of FIGS. 2A and 2B may be set in a range of between 10 and 33° or 15 and 65°. Each partition wall has a thickness ranging from 1 μm to 7 μm so as not to affect the haze of the polarization control unit.

Although the windows W defined by the partition walls PW of FIGS. 2A and 2B are rectangular-shaped, the shapes of the windows are not limited to this example and they may have various shapes.

The partition walls PW are disposed between the first substrate SUB1 and the second substrate SUB2 and support the first substrate SUB1 and the second substrate SUB2. This prevents the first and second electrodes E1 and E2 from being shorted due to substrate bending or external pressure.

Moreover, the polarization control unit having the thus-configured side walls PW can, when applied to the 2D/3D image display device as described later, can prevent moire caused by interference between the polarization control unit and the pixel electrodes of the display device.

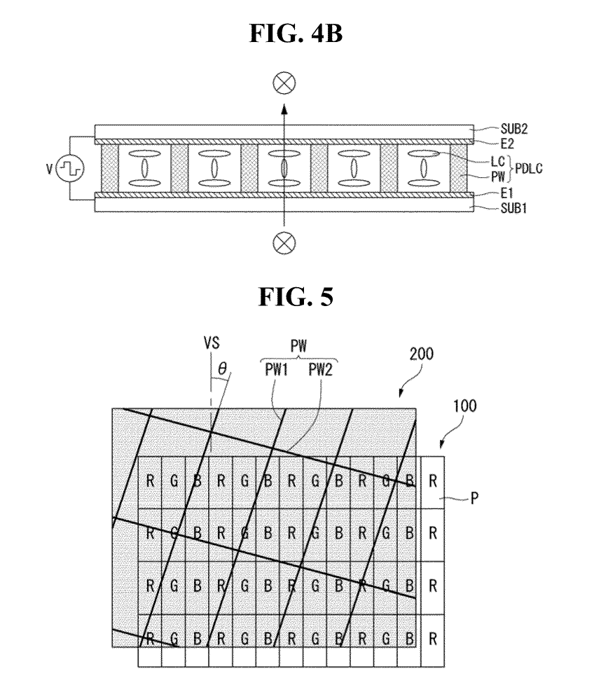

Next, a 2D/3D image display device having the polarization control unit according to the exemplary embodiment of the present invention will be described with reference to FIGS. 3 to 6. FIG. 3 is a cross-sectional view schematically illustrating a 2D/3D image display device having a polarization control unit according to an exemplary embodiment of the present invention. FIG. 4A is a cross-sectional view for explaining the direction of polarization of light when no electric field is applied to the polarization control unit of FIG. 3. FIG. 4B is a cross-sectional view for explaining the direction of polarization of light when an electric field is applied to the polarization control unit of FIG. 3. FIG. 5 is a top plan view schematically illustrating one example of the relationship between the pixel electrodes of the display panel and the polarization control unit shown in FIG. 3. FIG. 6 is a top plan view schematically illustrating another example of the relationship between the pixel electrodes of the display panel and the polarization control unit shown in FIG. 3.

Referring to FIG. 3, the 2D/3D image display device according to the exemplary embodiment of the present invention includes a display panel 100, a polarization control unit 200, and a switchable lens unit 300.

The display panel 100, which is a display device that displays 2D and 3D image data, includes flat panel displays such as a liquid crystal display (LCD), a field emission display (FED), a plasma display panel (PDP), an inorganic electroluminescence display, an electroluminescence (EL) display including an organic light emitting diode (OLED) and an inorganic light emitting diode, and an electrophoresis display (EPD). The following description will be given by taking an example where the display panel 100 is a liquid crystal display.

The display panel 100 includes a thin film transistor (TFT) substrate on which a pixel array including thin film transistors TFT is formed, a color filter substrate on which color filters representing colors are formed, and a liquid crystal layer disposed between the thin film transistor substrate and the color filter substrate. Polarizing plates, of which light absorption axes form about 90° with each other, are respectively attached to the surfaces of the thin film transistor substrate and color filter substrate of the display panel 100. Hence, light incident on the display panel 100 in either a horizontal or vertical direction is linearly polarized in a direction about 90° to the light absorption axis of the incident light and then comes out of the display panel 100.

The polarization control unit 200 is disposed on the display panel 100. The polarization control unit 200 transmits light supplied from the display panel 100 without refraction or linearly polarizes the light by about 90°, and then supplies it to the switchable lens unit 300. The polarization control unit 200 may be applied to a liquid crystal panel driven in a twisted nematic (TN) mode, a vertical alignment (VA) mode, an in-plane switching (IPS) mode, and a fringe field switching (FFS) mode.

As shown in FIG. 4A, when no electric field is applied to the polarization control unit, the liquid crystals are arranged so that the direction of linear polarization of incident light is rotated by about 90°, changing from vertical linear polarization (indicated by [symbol] ) to horizontal linear polarization (indicated by [symbol] ). On the other hand, as shown in FIG. 4B, when an electric field is applied to the polarization control unit, the liquid crystals are arranged to allow light pass through them without refraction. Hence, as shown in FIG. 4A, when no electric field is applied to the polarization control unit, the polarization control unit linearly polarizes light whose polarization axis is vertical [symbol] into light whose polarization axis is horizontal [symbol] and then transmits the light. As shown in FIG. 4B, when an electric field is applied to the polarization control unit, the polarization control unit transmits light whose polarization axis is vertical [symbol] without refraction, and thus the polarization axis of the transmitted light becomes vertical.

The switchable lens unit 300 is disposed on the polarization control unit 200. The switchable lens unit 300 transmits light without refraction to display a 2D image or separates the light into light corresponding to a right-eye image and light corresponding to a left-eye image to display a 3D image, depending on the direction of polarization of the light supplied from the polarization control unit 200. The switchable lens unit 300 is well known in the art, a detailed description thereof will be omitted.

Next, the relationship between the partition walls PW of the polarization control unit 200 and the pixel electrodes P of the display panel 100 according to the exemplary embodiment of the present invention will be described in more detail with reference to FIGS. 5 and 6.

Referring to FIG. 5, a plurality of partition walls PW of the polarization control unit comprise first partition walls PW1 configured to form a predetermined inclination angle θ with a vertical plane VS between the first and second substrates SUB1 and SUB2 of FIG. 1, and second partition walls PW2 arranged to cross the first partition walls PW1 at right angles. The distance (a first pitch) between the first partition walls and the distance (a second pitch) between the second partition walls are an integer multiple of the size of a pixel electrode of the display device. This will be described later in detail with reference to FIGS. 5 and 6.

In the example of FIG. 5, the inclination angle θ ranges from 10° to 33° or from 45° to 65°.

The distance (horizontal pitch) between the first partition walls PW1 is an integer multiple of the width (horizontal direction in the figure) of a pixel electrode P of the display panel 100. The distance (vertical pitch) between the second partition walls PW2 is an integer multiple of the height (vertical direction in the figure) of the pixel electrode P of the display panel 100.

Referring to FIG. 6, the partition walls PW of the polarization control unit are each configured to form a predetermined inclination angle θ with a vertical plane VS between the first and second substrates SUB1 and SUB2 of FIG. 1. In the example of FIG. 6, as in the example of FIG. 5, the angle θ ranges from 10° to 33° or from 45° to 65°. The distance between the partition walls PW, as well as the distance between the first partition walls PW1 of FIG. 5, is an integer multiple of the width (horizontal direction in the figure) of a pixel electrode P of the display panel 100.

FIG. 7 is a view a moire region and a moire-free region which appear depending on the inclination angle of the partition walls with respect to a vertical plane between the first and second substrates of the polarization control unit in the 2D/3D image display device according to the exemplary embodiment of the present invention. From FIG. 7, it is found out that no moire occurs at an angle ranging from 10 to 33° or from 45 to 65° but moire occurs at other angles.

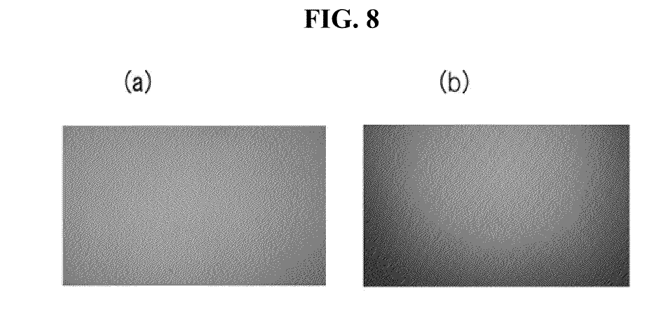

FIG. 8 is a photograph comparing the screen of the 2D/3 image display device according to the exemplary embodiment of the present invention and the screen of a related art 2D/3D image display device. While (a) of FIG. 8, taken of the screen of the 2D/3D image display device according to the exemplary embodiment of the present invention, shows that no moire was detected, (b) of FIG. 8, taken of the screen of the related art 2D/3D image display device, shows that moire was detected.

The above-described polarization control unit and 2D/3D image display device having the same according to the exemplary embodiments of the present inventions can prevent moire by eliminating interference with the pixel electrodes of the display device because the partition walls of the polarization control unit are arranged to form a predetermined inclination angle with a vertical plane.

From the foregoing description, those skilled in the art will readily appreciate that various changes and modifications can be made without departing from the technical ideas of the present invention. Therefore, the technical scope of the present invention is not limited to the contents described in the detailed description of the specification but defined by the appended claims.

What is claimed is:

1. A polarization control unit comprising:
a first substrate;
a second substrate positioned opposite the first substrate;
a first electrode disposed on a surface of the first substrate opposing the second substrate;
a second electrode disposed on a surface of the second substrate opposing the first substrate; and
a polymer-dispersed liquid crystal layer disposed between the first and second electrodes,
wherein the polymer-dispersed liquid crystal layer includes a plurality of partition walls supporting the first and second substrates, and liquid crystal molecules arranged in a space defined by the partition walls, and
wherein the partition walls are arranged to form a predetermined inclination angle with a vertical plane between the first and second substrates.

2. The polarization control unit of claim 1, wherein the partition walls comprise:
first partition walls arranged to form the predetermined inclination angle with a vertical plane between the first and second substrates; and
second partition walls arranged to cross the first partition walls.

3. The polarization control unit of claim 1, wherein the partition walls are arranged in parallel with each other in a same orientation.

4. The polarization control unit of claim 1, wherein the predetermined inclination angle ranges from 10 to 33° or from 45 to 65°.

5. A 2D/3D image display device comprising:
a display panel that displays an image with light linearly polarized in a first direction;
a polarization control unit that selectively switches light of the first direction to light linearly polarized in a second direction orthogonal to the first direction; and
a switchable lens unit that refracts light incident from the polarization control unit using a refractive index difference, and separates the refracted light into light for a left-eye image and light for a right-eye image to represent a 3D image or transmits the light incident from the polarization control unit without refraction to represent a 2D image.

6. The 2D/3D image display device of claim 5, wherein the distance between the partition walls of the polarization control unit is an integer multiple of a size of a pixel electrode of the display panel.
